(19) United States
(12) Patent Application Publication
(10) Pub. No.: US 2026/0029527 A1
(43) Pub. Date: Jan. 29, 2026

(54) DOPPLER CLUSTERING TECHNIQUES FOR PER CLUSTER PARAMETER ESTIMATION AND CLUSTER DETECTION

(71) Applicant: QUALCOMM Incorporated, San Diego, CA (US)

(72) Inventors: Ravinder KUMAR, San Diego, CA (US); Paolo MINERO, La Jolla, CA (US); Chao CHEN, Irvine, CA (US); Mahmoud Abdelmoneim ELGENEDY, Holden, MA (US); Hyeong Seok JEONG, San Diego, CA (US)

(21) Appl. No.: 18/784,491

(22) Filed: Jul. 25, 2024

(51) Int. Cl. G01S 15/58; G01S 7/486

(52) U.S. Cl. CPC G01S 15/582; G01S 7/4868

(57) ABSTRACT

Methods, systems, and devices for wireless communications are described. In some cases, a first network entity may receive multiple signals via multiple channels, where each signal of the multiple signals includes a same payload, and where multiple Doppler shifts are associated with the multiple signals. The UE may determine, based on multiple phase channel responses associated with the multiple signals, two or more clusters of signals from the multiple signals, where each signal of the multiple signals is associated with a respective phase channel response of the multiple phase channel responses based on a respective Doppler shift. Thus, the UE may detect, based on the two or more clusters, one or more communication conditions.

### INTRODUCTION

The following relates to wireless communications, including Doppler clustering techniques for per cluster parameter estimation and cluster detection.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a first network entity is described. The method may include receiving a set of multiple signals via a set of multiple channels, where each signal of the set of multiple signals includes a same payload, and where a set of multiple Doppler shifts is associated with the set of multiple signals, determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift, and detecting, based on the two or more clusters, one or more communication conditions.

A first network entity is described. The first network entity may include one or more memories storing processor executable code, and one or more processors coupled with the one or more memories. The one or more processors may individually or collectively be operable to execute the code to cause the first network entity to receive a set of multiple signals via a set of multiple channels, where each signal of the set of multiple signals includes a same payload, and where a set of multiple Doppler shifts is associated with the set of multiple signals, determine, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift, and detect, based on the two or more clusters, one or more communication conditions.

Another first network entity is described. The first network entity may include means for receiving a set of multiple signals via a set of multiple channels, where each signal of the set of multiple signals includes a same payload, and where a set of multiple Doppler shifts is associated with the set of multiple signals, means for determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift, and means for detecting, based on the two or more clusters, one or more communication conditions.

A non-transitory computer-readable medium storing code is described. The code may include instructions executable by one or more processors to receive a set of multiple signals via a set of multiple channels, where each signal of the set of multiple signals includes a same payload, and where a set of multiple Doppler shifts is associated with the set of multiple signals, determine, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift, and detect, based on the two or more clusters, one or more communication conditions.

Some examples of the method, first network entities, and non-transitory computer-readable medium described herein may further include operations, features, means, or instructions for generating a set of multiple bitmaps associated with the two or more clusters, where each bitmap of the set of multiple bitmaps corresponds to a respective cluster of the two or more clusters and determine, based on the set of multiple bitmaps, a respective set of one or more channel parameters associated each cluster of with the two or more clusters, where each respective set of one or more parameters may be based on a respective bitmap of the set of multiple bitmaps.

In some examples of the method, first network entities, and non-transitory computer-readable medium described herein, determining the respective set of one or more channel parameters associated with each cluster of the two or more clusters may include operations, features, means, or instructions for estimating, based on the set of multiple bitmaps, the respective set of one or more channel parameters associated with each cluster of the two or more clusters.

In some examples of the method, first network entities, and non-transitory computer-readable medium described herein, each respective set of one or more channel parameters includes a respective delay spread, a respective Doppler shift, a respective Doppler spread, a respective signal to noise ratio (SNR), or any combination thereof.

Some examples of the method, first network entities, and non-transitory computer-readable medium described herein may further include operations, features, means, or instructions for combining the respective sets of one or more channel parameters to generate a set of one or more combined channel parameters associated with the two or more clusters.

Some examples of the method, first network entities, and non-transitory computer-readable medium described herein may further include operations, features, means, or instructions for performing frequency tracking based on the set of one or more combined channel parameters.

Some examples of the method, first network entities, and non-transitory computer-readable medium described herein may further include operations, features, means, or instructions for performing demodulation based on the set of one or more combined channel parameters.

In some examples of the method, first network entities, and non-transitory computer-readable medium described herein, determining the two or more clusters of signals may include operations, features, means, or instructions for comparing each phase channel response of the set of multiple phase channel responses to one or more thresholds, determining, based on the comparison, two or more clusters of phase channel responses from the set of multiple phase channel responses, and determining, based on the two or more clusters of phase channel responses, the two or more clusters of signals from the set of multiple signals, where each second cluster of the two or more clusters of phase channel responses corresponds to a respective cluster of the two or more clusters of signals.

In some examples of the method, first network entities, and non-transitory computer-readable medium described herein, a movement speed of the first network entity or a target Doppler shift.

Some examples of the method, first network entities, and non-transitory computer-readable medium described herein may further include operations, features, means, or instructions for generating a flag based on the detection of the one or more communication conditions.

Some examples of the method, first network entities, and non-transitory computer-readable medium described herein may further include operations, features, means, or instructions for adapting, based on the flag, one or more operations.

In some examples of the method, first network entities, and non-transitory computer-readable medium described herein, adapting the one or more operations may include operations, features, means, or instructions for adjusting channel state feedback (CSF) reporting.

Some examples of the method, first network entities, and non-transitory computer-readable medium described herein may further include operations, features, means, or instructions for adapting, based on the detection of the one or more communication conditions, one or more operations.

In some examples of the method, first network entities, and non-transitory computer-readable medium described herein, adapting the one or more operations may include operations, features, means, or instructions for adjusting channel state feedback reporting.

Some examples of the method, first network entities, and non-transitory computer-readable medium described herein may further include operations, features, means, or instructions for filtering the set of multiple phase channel responses to generate a set of filtered phase channel responses, where, to detect the one or more communication conditions, the first network entity detects, based on the two or more clusters including the set of filtered phase channel responses, the one or more communication conditions.

In some examples of the method, first network entities, and non-transitory computer-readable medium described herein, the set of multiple signals includes a set of multiple repetitions of a same signal.

In some examples of the method, first network entities, and non-transitory computer-readable medium described herein, receiving the set of multiple signals may include operations, features, means, or instructions for receiving the set of multiple signals from one or more second network entities, where the one or more communication conditions may be for communication between the first network entity and the one or more second network entities.

In some examples of the method, first network entities, and non-transitory computer-readable medium described herein, the one or more second network entities include a single second network entity and each signal of the set of multiple signals may be associated with a respective communication path between the first network entity and the single second network entity.

In some examples of the method, first network entities, and non-transitory computer-readable medium described herein, the one or more second network entities include a set of multiple second network entities and each signal of the set of multiple signals may be associated with a respective second network entity of the set of multiple second network entities.

In some examples of the method, first network entities, and non-transitory computer-readable medium described herein, the first network entity includes a user equipment (UE) and the one or more second network entities include one or more remote radio heads.

In some examples of the method, first network entities, and non-transitory computer-readable medium described herein, one or more single frequency network (SFN) conditions or one or more dynamic point selection (DPS) conditions.

In some examples of the method, first network entities, and non-transitory computer-readable medium described herein, the set of multiple Doppler shifts may be indicative of the first network entity being configured to operate in a high speed train scenario.

In some examples of the method, first network entities, and non-transitory computer-readable medium described herein, the set of multiple signals include either a set of multiple synchronization signal blocks (SSBs) or a set of multiple tracking reference signals (TRSs).

In some examples of the method, first network entities, and non-transitory computer-readable medium described herein, the set of multiple synchronization signal blocks and the set of multiple tracking reference signals may be not associated with a quasi-co-location relationship.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports Doppler clustering techniques for per cluster parameter estimation and cluster detection in accordance with one or more aspects of the present disclosure.

FIGS. 2A and 2B each show an example of a wireless communications system that supports Doppler clustering techniques for per cluster parameter estimation and cluster detection in accordance with one or more aspects of the present disclosure.

FIG. 3 shows an example of a cluster diagram that supports Doppler clustering techniques for per cluster parameter estimation and cluster detection in accordance with one or more aspects of the present disclosure.

FIG. 4 shows an example of a block diagram that supports Doppler clustering techniques for per cluster parameter estimation and cluster detection in accordance with one or more aspects of the present disclosure.

FIG. 5 shows an example of a process flow that supports Doppler clustering techniques for per cluster parameter estimation and cluster detection in accordance with one or more aspects of the present disclosure.

FIGS. 6 and 7 show block diagrams of devices that support Doppler clustering techniques for per cluster parameter estimation and cluster detection in accordance with one or more aspects of the present disclosure.

FIG. 8 shows a block diagram of a communications manager that supports Doppler clustering techniques for per cluster parameter estimation and cluster detection in accordance with one or more aspects of the present disclosure.

FIG. 9 shows a diagram of a system including a device that supports Doppler clustering techniques for per cluster parameter estimation and cluster detection in accordance with one or more aspects of the present disclosure.

FIGS. 10 and 11 show flowcharts illustrating methods that support Doppler clustering techniques for per cluster parameter estimation and cluster detection in accordance with one or more aspects of the present disclosure.

### DETAILED DESCRIPTION

In some wireless communication systems, a user equipment (UE) may operate in a high-speed train (HST) scenario. In such cases, the UE may move at or above a threshold velocity (e.g., while on an HST) through a coverage area of multiple network entities. Thus, to maintain performance of the UE, the UE may support one or more communication techniques, such as a single frequency network (SFN) or dynamic point selection (DPS). When supporting the SFN, the UE may simultaneously receive multiple signals from multiple network entities (e.g., radio resource heads (RRHs)), where each of the multiple signals include a same payload. When supporting DPS, the UE may simultaneously receive multiple singles from a single network entity (e.g., RRH) via multiple paths, where each of the multiple signals include a same payload. In either cases, each of the multiple signals may be associated with a different Doppler shift due to differences in angle of arrival, a velocity of the UE, or both. Thus, to maintain a performance of the UE while supporting the SFN, DPS, or the like thereof, the UE may need to adjust one or more operations of the UE based on a large delay spread, a large Doppler spread, or both, due to the different Doppler shifts (e.g., as compared to non-SFN or non-DPS scenarios). Thus, a network entity may transmit a network flag to the UE to indicate a presence of one or more communication conditions resulting in a large Doppler spread (e.g., one or more SFN conditions, one or more DPS conditions). However, not all UEs may support the network flag, transmission of the network flag may be unreliable, or both.

Accordingly, techniques described herein may enable a UE to detect the one or more communication conditions (e.g., without reception of a network flag). For example, the UE may receive multiple signals from one or more network entities (e.g., RRHs), where each signal of the multiple signals is associated with a same payload and where the multiple signals are associated with a corresponding set of multiple Doppler shifts. The is, each signal of the multiple signals may be associated with a different Doppler shift of the multiple Doppler shifts. The UE may determine two or more clusters of signals (e.g., of the multiple signals) based on respective phase channel responses associated with the multiple signals. For example, the UE may group the multiple signals into the two or more clusters based on comparing the respective phase channel responses to one or more thresholds (e.g., threshold phase channel responses).

Thus, the UE may detect the one or more communication conditions (e.g., SFN conditions, DPS conditions) for the wireless communications between the UE and the one or more network entities based on the two or more clusters. In some cases, the UE may additionally adapt one or more operations of the UE based on detection of the one or more communication conditions. For example, the UE may adjust channel state feedback (CSF) feedback reporting based on detection of the one or more communication conditions.

Aspects of the disclosure are initially described in the context of wireless communications systems. Aspects of the disclosure are then described in the context of a cluster diagram, a block diagram, and a process flow. Aspects of the disclosure are further illustrated by and described with reference to apparatus diagrams, system diagrams, and flowcharts that relate to doppler clustering techniques for per cluster parameter estimation and cluster detection.

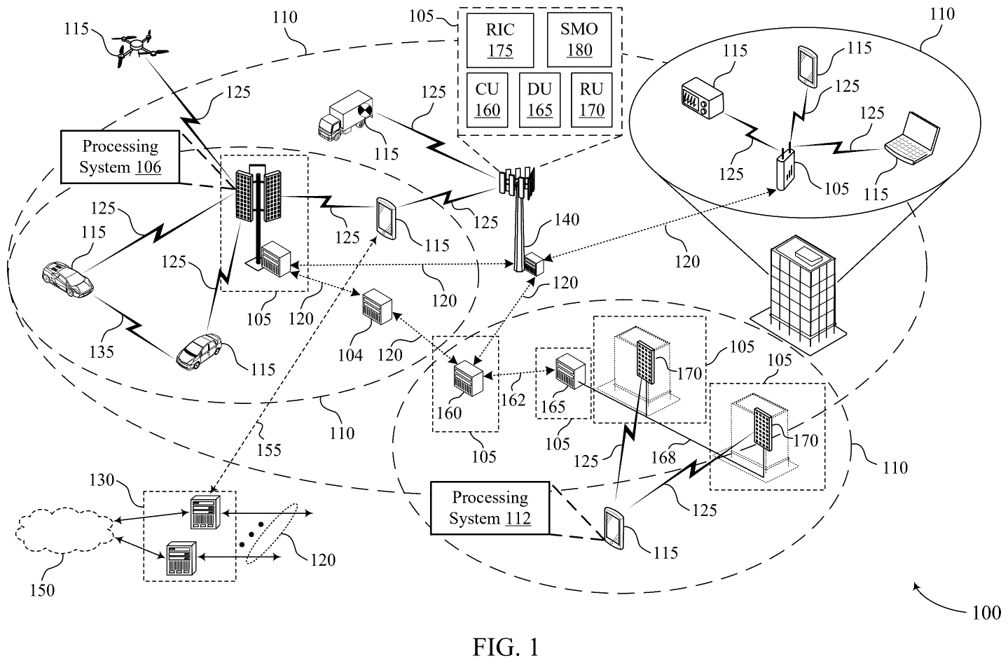

FIG. 1 shows an example of a wireless communications system 100 that supports Doppler clustering techniques for per cluster parameter estimation and cluster detection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (cRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some cases, the wireless communications system 100 may support techniques to enable a UE 115 to detect the one or more communication conditions (e.g., without reception of a network flag). For example, the UE 115 may receive multiple signals from one or more network entities 105 (e.g., RRHs), where each signal of the multiple signals is associated with a same payload and where the multiple signals are associated with a corresponding set of multiple Doppler shifts. The is, each signal of the multiple signals may be associated with a different Doppler shift of the multiple Doppler shifts. The UE 115 may determine two or more clusters of signals (e.g., of the multiple signals) based on respective phase channel responses associated with the multiple signals. For example, the UE 115 may group the multiple signals into the two or more clusters based on comparing the respective phase channel responses to one or more thresholds (e.g., threshold phase channel responses). Thus, the UE 115 may detect the one or more communication conditions (e.g., SFN conditions, DPS conditions) for the wireless communications between the UE 115 and the one or more network entities 105 based on the two or more clusters. In some cases, the UE 115 may additionally adapt one or more operations of the UE 115 based on detection of the one or more communication conditions. For example, the UE 115 may adjust CSF feedback reporting based on detection of the one or more communication conditions.

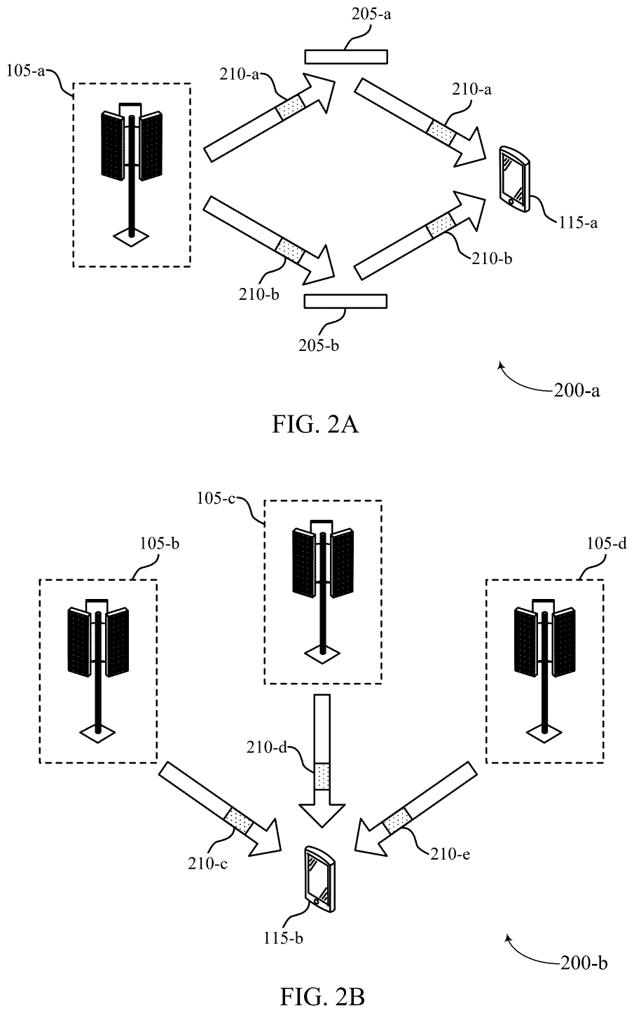

FIGS. 2A and 2B each show an example of a wireless communications system 200 (e.g., a wireless communications system 200-a and a wireless communications system 200-b) that supports Doppler clustering techniques for per cluster parameter estimation and cluster detection in accordance with one or more aspects of the present disclosure. In some cases, the wireless communications systems 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a, a network entity 105-b, a network entity 105-c, and a network entity 105-d), which may be examples of the corresponding devices as described herein.

In some wireless communication systems, such as the wireless communications system 200-a and the wireless communications system 200-b, a UE 115, such as the UE 115-a and the UE 115-b, may operate in an HST scenario. In such cases, the UE 115 may move at or above a threshold velocity (e.g., speed) through a coverage area of multiple network entities 105 (e.g., on an HST). Thus, to maintain performance of the UE 115, the UE 115 may support one or more communication techniques, such as an SFN, as depicted in FIG. 2A, or DPS, as depicted in FIG. 2B. In some examples, performance of the UE 115 (e.g., supporting the SFN or DPS) may be tested using Fixed Modulation and Coding Scheme (FMCS) performance tests, internal comp tests with link adaptation, China Mobile Communications Corporation (CMCC) Product Approval (PA) pre-certification conformance tests, or any combination thereof.

For example, as depicted in FIG. 2A, a UE 115 (e.g., on an HST), such as the UE 115-a, may support DPS (e.g., HST DPS with fading) in which the UE 115-a may simultaneously receive multiple signals 210 from a same network entity 105 (e.g., a same RRH) via different paths (e.g., communication paths), where each of the multiple signals 210 includes a same payload. That is, each signal 210 of the multiple signals 210 may be a repetition of a same signal 210 received (e.g., and transmitted) via a different path. For example, the UE 115-a may receive a signal 210-a from the network entity 105-a via a first path (e.g., via a reflector 205-a) and may receive a signal 210-b from the network entity 105-a via a second path (e.g., via a reflector 205-b), where the signal 210-a and the signal 210-b include the same payload (e.g., are repetitions of the same signal 210).

In another example, as depicted in FIG. 2B, a UE 115 (e.g., on an HST), such as the UE 115-b, may support an SFN (e.g., HST SFN) in which the UE 115-b may simultaneously receive multiple signals 210 from multiple network entities 105 (e.g., multiple RRHs), where each of the multiple signals 210 includes a same payload. That is, each signal 210 of the multiple signals 210 may be a repetition of a same signal 210 received from (e.g., and transmitted by) a different network entity 105 of the multiple network entities 105. For example, the UE 115-b may receive a signal 210-c from the network entity 105-b, a signal 210-d from the network entity 105-c, and a signal 210-e from the network entity 105-d, where the signal 210-c, the signal 210-d, and the signal 210-e include the same payload (e.g., are repetitions of the same signal 210).

In either case (e.g., SFN or DPS with fading), the multiple signals 210 may be associated with different Doppler shifts due to different angles of arrivals (e.g., of each signal 210), a velocity (e.g., speed, rate of distance over time) of the respective UE 115 (e.g., the UE 115-a or the UE 115-b), or both. That is, each signal 210 of the multiple signals may be associated with a different Doppler shift due to a respective angle of arrival (e.g., of each signal 210), a high velocity (e.g., velocity at or above the threshold velocity) of the UE 115 (e.g., the UE 115-a or the UE 115-b), or both.

Thus, to maintain a performance of the UE while supporting the SFN, DPS, or the like thereof, the UE 115 may adjust one or more operations of the UE 115 based on a large delay spread (e.g., threshold delay spread), a large Doppler spread (e.g., threshold Doppler spread), or both (e.g., as compared to non-SFN or non-DPS scenarios). That is, the different Doppler shifts of the multiple signals 210 may result in the large delay spread, the large Doppler spread, or both, which may impact the one or more operations of the UE 115 such that, to maintain performance of the UE 115, the UE 115 may adjust (e.g., may need to adjust) the one or more operations of the UE 115. As such, in some cases, a network entity 105 (e.g., the network entity 105-a, the network entity 105-b, the network entity 105-c, the network entity 105-d, or any combination thereof) may transmit a network flag (e.g., highSpeedDemodFlag-r16) to signal one or more communication conditions of the UE 115 to enable the UE 115 to adapt the one or more operations (e.g., adopt receivers suited for the one or more communication conditions). For example, the network flag may signal one or more SFN conditions experienced by (e.g., deployments of) the UE 115. However, not all UEs 115 may support reception of the network flag (e.g., only synchronization signal blocks (SSBs) may be transmitted in an SFN manner, while other physical channels may be sent in a DPS manner), communication (e.g., transmission or reception) of the network flag may not be reliable (e.g., may be associated with a failure rate exceeding a threshold), or both. Additionally, or alternatively, some wireless communications systems (e.g., other networks) may enable signaling of the network flag for non-SFN scenarios, which may lead to decreases in performance of the UE 115.

Accordingly, techniques described herein may enable a UE 115, such as the UE 115-a and the UE 115-b, to detect the one or more communication conditions (e.g., one or more SFN conditions, one or more DPS conditions, or both) in HST scenarios based on Doppler clustering. Specifically, the techniques described herein may enable the UE 115 to detect the one or more communication conditions (e.g., run an algorithm) separately for SSBs and tracking reference signals (TRSs), resulting in improvements in channel estimation (e.g., as compared to detecting the one or more communication conditions jointly for SSB and TRS).

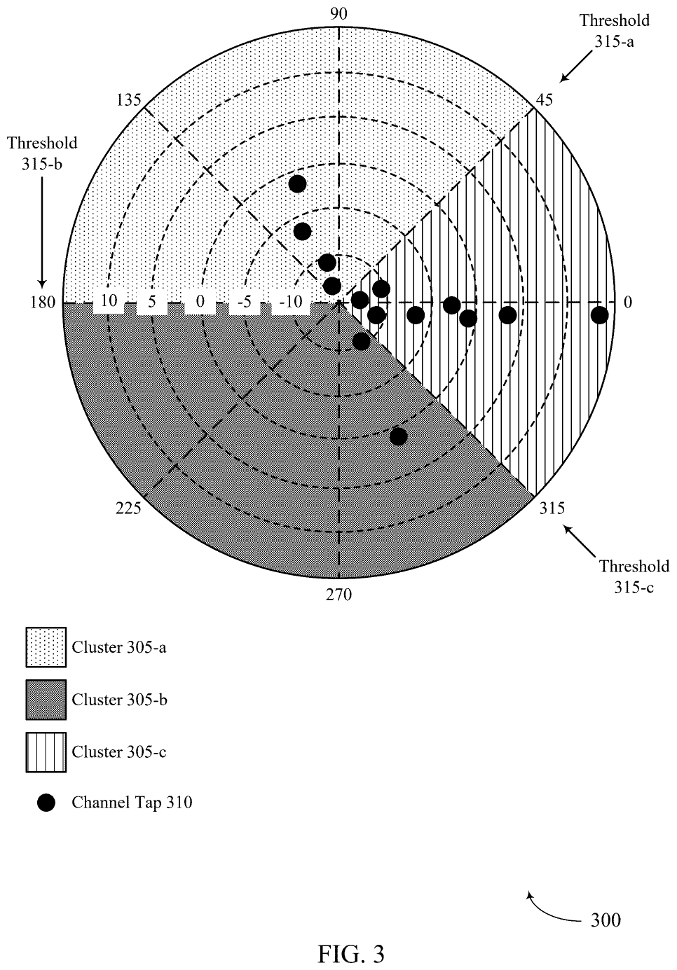

For example, techniques described herein may enable the UE 115 (e.g., using the algorithm) to separate multiple phase channel responses into multiple clusters of channel taps, where each cluster of the multiple clusters may include one or more channel taps sharing (e.g., associated with) a similar Doppler shift (e.g., Doppler shift within a threshold deviance), as described further with reference to FIG. 3. A channel tap may refer to a signal received via a channel. Thus, when two or more (e.g., practically three or more) clusters are identified by the UE 115, the UE 115 may detect the one or more communication conditions. As discussed herein, the UE 115 may detect the one or more communication conditions (e.g., may run the algorithm separately) for SSB (e.g., NR-SSB) and TRS (e.g., NR-TRS) to generate UE-based channel-specific flag indicators (e.g., flags generated based on detection of the one or more communication conditions, SFN flag indicator), which may support scenarios (e.g., deployments similar to HST networks) where SSB and TRS may not be quasi-co-located (QCLed) (e.g., may not be associated with a QCL relationship.

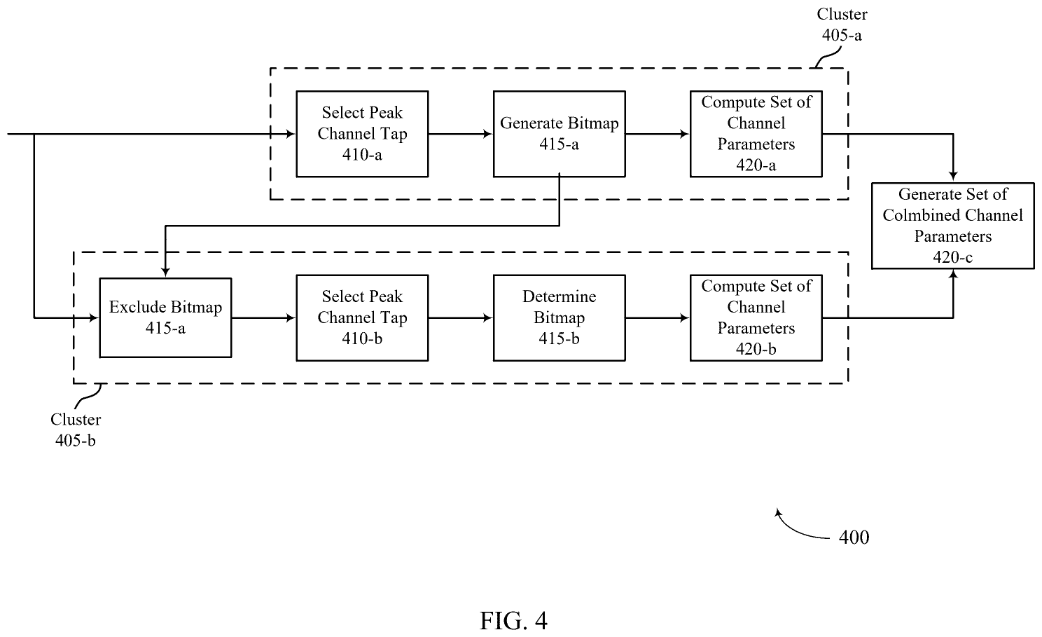

Thus, the UE 115 (e.g., modem) may adjust or adapt one or more operations of the UE 115 (e.g., enable SFN demodulation enhancements) based on detection of the one or more communication conditions (e.g., regardless of whether the UE 115 receives highSpeedDemodFlag-r16). Additionally, or alternatively, if SSB and TRS are associated with different indicators, the UE 115 may adjust a priority given to the SSB and the TRS (e.g., two pilots) and may prioritize whichever signal (e.g., the SSB or the TRS) is QCLed with demodulation reference signal (DMRS)-physical downlink shared channel (PDSCH). Additionally, or alternatively, the UE 115 may transmit a second flag (e.g., the UE-based channel-specific indicator) based on detection of the one or more communication conditions (e.g., to original equipment manufacturers (OEMs) for HST-specific algorithms, to another layer of the UE 115). That is, the UE 115 may provide the second flag (e.g., indication for HST) to another layer in the UE 115 even when the UE 115 has not received a first flag from a network entity 105 (e.g., from system information block (SIB) information). Additionally, or alternatively, the UE 115 may estimate (e.g., determine) one or more channel parameters (e.g., may use a channel estimation algorithm) for each cluster of the multiple clusters separately, which may result in improved demodulation performance, as described with reference to FIG. 4. In particular, the UE 115 may be able to achieve a same performance (e.g., as with Rel 17 HST Scheme A) with UE-specific improvements and without any network changes. In some cases, the UE 115 may alter or adjust channel state feedback (CSF) reporting based on detection of the one or more communication conditions (e.g., to enable CSF to better suite the one or more communication conditions

FIG. 3 shows an example of a cluster diagram 300 that supports Doppler clustering techniques for per cluster parameter estimation and cluster detection in accordance with one or more aspects of the present disclosure. In some cases, the cluster diagram 300 may implement or be implemented by aspects of the wireless communications system 100, the wireless communications systems 200, or both. For example, the cluster diagram 300 may be implemented by one or more UEs 115 and one or more network entities 105, which may be examples of the corresponding devices as described herein.

As described previously with reference to FIG. 3, to detect one or more communication conditions (e.g., one or more SFN conditions, one or more DPS conditions, or both), a UE 115 may receive multiple signals (e.g., from one or more network entities), where each of the multiple signals may include a same payload but may be associated with a different Doppler shift. Additionally, the UE may determine two or more clusters 305 (e.g., of signals of the multiple signals) based on different phase channel responses corresponding to the different Doppler shifts (e.g., associated with each signal). That is, the UE 115 (e.g., an algorithm run by the UE 115) may group the multiple signals using (e.g., based on) a respective phase of cross correlation, r01, between the multiple signals (e.g., pilot signals) sent on two separate OFDM symbols (e.g., TRS or SSB), where the phase of the cross correlation is the phase channel response.

For example, each signal of the multiple signals, which may be referred to as a channel tap 310, may be associated with a respective delay, a respective Doppler shift, or both, such that a channel (e.g., corresponding to a channel tap 310) may be associated with a channel delay spread, a channel Doppler spread, or both, based on the respective delay, the respective Doppler shift, or both. Additionally, a respective phase associated with each channel tap 310 may be proportional (e.g., correspond) to a respective Doppler shift associated with each channel tap 310, where the respective phase may be used to determine a phase of cross correlation, or phase channel response, associated with the respective channel tap 310.

Thus, the UE 115 may identify two or more clusters 305 of channel taps 310 based on the respective phase channel responses. For example, the cluster diagram 300 may depict a phase of cross correlation associated with each channel tap 310 of the multiple channel taps 310 (e.g., may be an r01 cluster diagram 300), where each channel tap 310 of the multiple channel taps 310 may be associated with a different phase of cross correlation (e.g., at least a subset of the multiple channel taps 310 may be associated with different phase of cross correlations). Thus, the UE 115 may group the multiple channel taps 310 based on one or more thresholds 315 (e.g., phase thresholds 315) associated with multiple clusters 305. That is, the UE 115 may compare a phase of cross correlation associated with a channel tap 310 (e.g., of the multiple channel taps 310) to the one or more thresholds 315 and may assign the channel tap 310 to a cluster 305 of the multiple clusters 305 based on the comparison, repeating the aforementioned comparison and assignment for each channel tap 310 of the multiple channel taps 310. In other words, the UE 115 may group the phases of cross correlation (e.g., associated with the multiple channel taps 310) into the multiple clusters 305, where grouping the phases of cross correlation inherently groups the associated multiple channel taps 310 into the multiple clusters 305.

For example, for detection of three clusters 305 (e.g., for a three cluster detection algorithm), the UE 115 may define (e.g., generate, identify) a cluster 305-a including channel taps 310 each associated with an absolute value of an arc tangent (e.g., inverse tangent) of a phase of cross correlation (e.g., r01) less than or equal to a threshold 315-a (e.g., |a tan(r01)|≤TH_{θ}), a cluster 305-b including channel taps 310 each associated with an arc tangent of a phase of cross correlation greater than the threshold 315-a (e.g., a tan(r01)>TH_{θ}), and a cluster 305-c including channel taps 310 each associated with an arc tangent of a phase of cross correlation less than an inverse of the threshold 315-a (e.g., a tan(r01)<−TH_{θ}). In other words, the multiple channel taps 310 may be grouped into a first set of channel taps 310 associated with the cluster 305-a, a second set of channel taps 310 associated with the cluster 305-b, and a third set of channel taps 310 associated with the cluster 305-c based on respective phases of cross correlation.

In such cases, each channel tap 310 of the first set of channel taps 310 (e.g., of the cluster 305-a) may be associated with a respective absolute value of an arc tangent of a respective phase of cross correlation (e.g., a respective phase channel response) between the threshold 315-a and a threshold 315-c (e.g., an inverse of the threshold 315-a), each channel tap 310 of the second set of channel taps 310 (e.g., of the cluster 305-b) may be associated with a respective arc tangent of a respective phase of cross correlation greater than the threshold 315-a but less than a threshold 315-b (e.g., 180°), and each channel tap 310 of the third set of channel taps 310 (e.g., of the cluster 305-c) may be associated with a respective arc tangent of a respective phase of cross correlation less than the threshold 315-c but greater than the threshold 315-b. In some examples, the threshold 315-b and the threshold 315-c may be based on the threshold 315-a. Additionally, or alternatively, any combination of the threshold 315-a, the threshold 315-b, and the threshold 315-c may be based on a target Doppler (e.g., a velocity of the UE 115 in HST). In some cases, expected behavior may be that in some channels (e.g., legacy channels, Additive White Gaussian Noise (AWGN) channels, Tapped Delay Line (TDL-x) channels, such as TDL-A, TDL-B, and TDL-C, etc.).

Thus, the UE 115 may detect one or more communication conditions (e.g., one or more SFN conditions, one or more DPS conditions, or both) based on the two or more clusters 305 (e.g., based on grouping the multiple channel taps 310 into two or more clusters 305). That is, in the example of FIG. 3, if all of the multiple channel taps 310 are assigned (e.g., grouped) into a single cluster 305 (e.g., due to the respective phases of cross correlation relative to the one or more thresholds 315), the UE 115 may determine that the one or more communication conditions are not present. Conversely, as depicted in FIG. 3, the multiple channel taps 310 are assigned to the cluster 305-a, the cluster 305-b, and the cluster 305-c, such that the UE 115 may identify that the one or more communication conditions are present.

In some examples, the UE 115 may filter the Doppler shifts (e.g., corresponding to the respective phases used to determine the respective phases of cross correlations) associated with the multiple channel taps 310 (e.g., after to the grouping) to reduce detection false alarms (e.g., detection of the one or more communication conditions when the one or more communication conditions are not present). For example, a channel may be associated with a nominal Doppler spread+/−400 Hz but may occasionally be associated with Doppler values greater than 500 Hz. However, after filtering, the Doppler values (e.g., metrics) may converge to an expected range (e.g., +/−400 Hz). In other words, the respective phases of cross correlations considered when grouping the multiple channel taps 310 may be filtered phases of cross correlation (e.g., based on filtering the Doppler shifts corresponding to the respective phases used to determine the respective phases of cross correlations). Filtering the Doppler shifts may enable the UE 115 to consistently generate the same clusters 305 over time (e.g., generate the multiple clusters 305 using the same one or more thresholds).

In some cases, the UE 115 may estimate one or more channel parameters associated with each cluster 305 based on detection of the one or more communication conditions, as described further with reference to FIG. 4. Additionally, or alternatively, the UE 115 may adjust or adapt one or more operations of the UE 115 based on detection of the one or more communication conditions, as described with reference to FIG. 3.

Detecting the one or more communication conditions in accordance with the techniques described herein may achieve one or more performance benefits. For example, the UE 115 may achieve increased throughput (e.g., in HST SFN scenarios) due to per-cluster channel parameter estimation resulting in increased quality of channel estimates and performance boosts (e.g., as compared to not performing per-cluster channel estimation). For example, the UE 115 may achieve 30% throughout enhancement (e.g., on CMCC HST DPS PA test) as compared to not performing per-cluster channel estimation. Additionally, performance of the UE 115 may not depend on reception of a network flag (e.g., higher performance gain regardless of the network flag highSpeedDemodFlag-r16).

Though described in the context of three clusters 305, this is not to be regarded as a limitation of the present disclosure. In this regard, any quantity of clusters 305 may be supported with regards to the techniques described herein

FIG. 4 shows an example of a block diagram 400 that supports Doppler clustering techniques for per cluster parameter estimation and cluster detection in accordance with one or more aspects of the present disclosure. In some cases, the block diagram 400 may implement or be implemented by aspects of the wireless communications system 100, the wireless communications systems 200, the cluster diagram 3, or any combination thereof. For example, the block diagram 400 may be implemented by one or more UEs 115 and one or more network entities 105, which may be examples of the corresponding devices as described herein.

In some cases, as described with reference to FIG. 3, a UE 115 may estimate one or more channel parameters associated with each cluster 405 (e.g., of multiple clusters 405) based on detection of one or more communication conditions. That is, the UE 115 may group multiple channel taps 410 into multiple clusters 405 (e.g., based on respective phase channel responses), including a cluster 405-a and a cluster 405-b, and may detect the one or more communication conditions based on grouping the multiple channel taps into the multiple clusters 405, such that the UE 115 may determine (e.g., compute, estimate) a set of channel parameters 420-a associated with the cluster 405-a and a set of channel parameters 420-b associated with the cluster 405-b (e.g., per-cluster channel parameters).

To compute the set of channel parameters 420-a and the set of channel parameters 420-b, the UE 115 may perform the operations defined in the block diagram 400. For example, the UE 115 may select a peak channel tap 410-a associated with the cluster 405-a (e.g., a peak channel tap 410-a associated with a primary RRH, i_{P}_{_{PRH}}) and may generate (e.g., find, determine) a bitmap 415-a associated with the cluster 405-a based on the peak channel tap 410-a. Thus, the UE 115 may compute the set of channel parameters 420-a associated with the cluster 405-a based on the bitmap 415-a. In some cases, the set of channel parameters 420-a may include any combination of: a first delay spread, a first Doppler shift, a first Doppler spread, and a first SNR.

Thus, to compute the set of channel parameters 420-b, the UE 115 may first exclude the bitmap 415-a from consideration with reference to the cluster 405-b. Similar to the cluster 405-a, the UE 115 may select a peak channel tap 410-b associated with the cluster 405-b (e.g., a peak channel tap 410-b associated with a secondary RRH, iₛ_{_{RRH}}) and may generate a bitmap 415-b associated with the cluster 405-b based on the peak channel tap 410-b. Thus, the UE 115 may compute the set of channel parameters 420-b associated with the cluster 405-b based on the bitmap 415-b. In some cases, the set of channel parameters 420-b may include any combination of: a second delay spread, a second Doppler shift, a second Doppler spread, and a second SNR.

Additionally, in some cases, the UE 115 may combine the set of channel parameters 420-a and the set of channel parameters 420-b to generate a set of combined channel parameters 420-c. For example, the UE 115 may combine the first delay spread and the second delay spread to generate a combined delay spread, may combine the first Doppler shift and the second Doppler shift to generate a combined Doppler shift, may combine the first Doppler spread and the second Doppler spread to generate a combined Doppler shift, may combine the first SNR and the second SNR to generate a combined SNR, or any combination thereof. As such, the UE 115 may perform (e.g., or adjust) one or more operations of the UE 115 based on one or more combined channel parameters of the set of combined channel parameters 420-c. For example, the UE 115 may perform frequency tracking based on combining the first Doppler shift associated with the cluster 405-a and the second Doppler shift associated with the cluster 405-b (e.g., based on the combined Doppler shift). Additionally, or alternatively, the UE 115 may perform channel estimation (e.g., including a time domain phase step) based on any combination of the set of channel parameters 420-a, the set of channel parameters 420-b, and the set of combined channel parameters 420-c (e.g., or any subset of channel parameters).

Though described in the context of two clusters 405, this is not to be regarded as a limitation of the present disclosure. In this regard, any quantity of clusters 405 may be supported with regards to the techniques described herein.

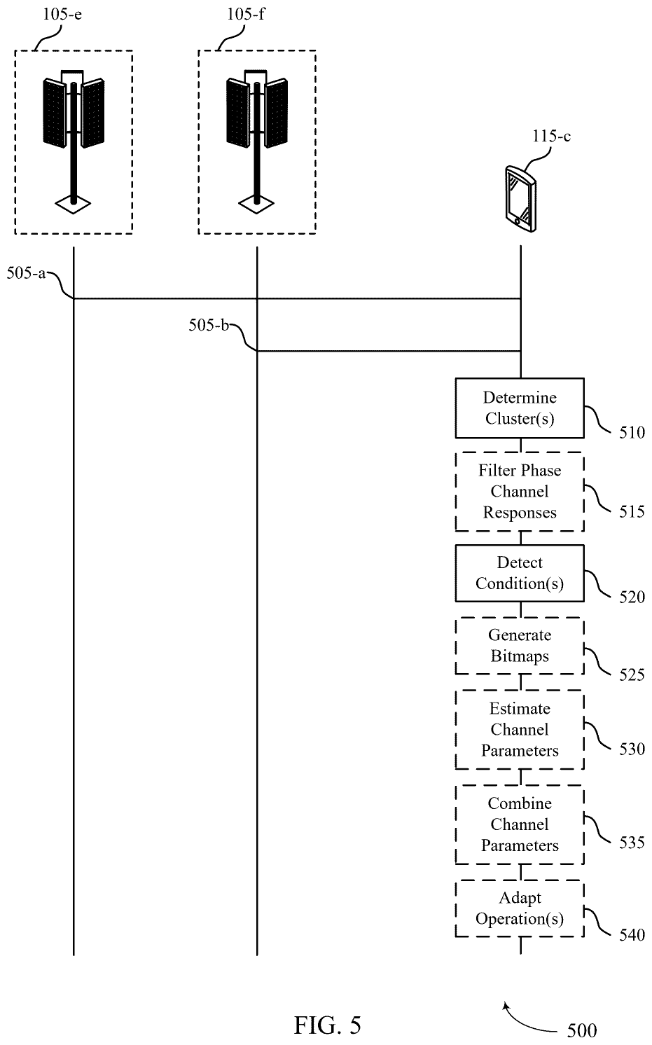

FIG. 5 shows an example of a process flow 500 that supports Doppler clustering techniques for per cluster parameter estimation and cluster detection in accordance with one or more aspects of the present disclosure. In some cases, the process flow 500 may implement or be implemented by aspects of the wireless communications system 100, the wireless communications system 200, the cluster diagram 300, the block diagram 400, or any combination thereof. For example, the process flow 500 may include one or more UEs 115 (e.g., a UE 115-c) and one or more network entities 105 (e.g., a network entity 105-e and a network entity 105-f), which may be examples of the corresponding devices as described herein. In the following description of the process flow 500, the operations between any combination of the UE 115-c, the network entity 105-e, and the network entity 105-f may be transmitted in a different order than the example order shown, or the operations performed by the UE 115-c, the network entity 105-e, the network entity 105-f, or any combination thereof, may be performed in different orders or at different times. Some operations may also be omitted from the process flow 500, and other operations may be added to the process flow 500.

At 505, the UE 115-c (e.g., first network node) may receive multiple signals (e.g., multiple channel taps) from one or more network entities 105 (e.g., one or more second network nodes, RRHs) via multiple channels, where each of the multiple signals may be associated with a same payload (e.g., the multiple signals may include multiple repetitions of a same signal). Additionally, the multiple signals may be associated with a corresponding set of multiple Doppler shifts (e.g., based on the UE 115-c operating in accordance with an HST scenario). That is, each of the multiple signals may be associated with a respective Doppler shift of the multiple Doppler shifts. In such cases, the multiple Doppler shifts may be indicative of the UE 115-c being configured to operate in an HST scenario (e.g., being configured to support an SFN or DPS).

In some cases, as depicted in FIG. 5, the UE 115-c may receive the multiple signals from multiple network entities 105 (e.g., according to an SFN scenario). For example, at 505-a, the UE 115-c may receive a first signal (e.g., a first repetition) of the multiple signals (e.g., of the multiple repetitions) from the network entity 105-e, where the first signal is associated with a first Doppler shift of the set of multiple Doppler shifts, and, at 505-b, may receive a second signal (e.g., a second repetition) of the multiple signals (e.g., of the multiple repetitions) from the network entity 105-f, where the second signal is associated with a second Doppler shift of the set of multiple Doppler shifts (e.g., different than the first Doppler shift).

In some other cases (e.g., not depicted), the UE 115-c may receive the multiple signals from a single network entity 105 via multiple paths. For example, the UE 115-c may receive the first signal from the network entity 105-e via a first path and may receive the second signal from the network entity 105-e via a second path. In such cases, the first signal may similarly be associated with the first Doppler shift and the second signal may similarly be associated with the second Doppler shift (e.g., and both signals may carry the same payload).

In some cases, the multiple signals may include either multiple SSBs or multiple TRSs. In such cases, the multiple SSBs and the multiple TRSs may not be associated with a QCL relationship.

At 510, the UE 115-c may determine, based on multiple phase channel responses associated with the multiple signals, two or more clusters of signals from the multiple signals. In such cases, the plurality of phase channel responses may be based on the multiple Doppler shifts. That is, each signal of the multiple signals may be associated with a Doppler shift of the set of multiple Doppler shifts the corresponds to (e.g., based on) a respective phase channel response (e.g., phase) of the multiple phase channel responses.

In some examples, to determine the two or more clusters, the UE 115-c may compare each phase channel response of the plurality of phase channel responses to one or more thresholds, may determine, based on the comparison, two or more clusters of phase channel responses (e.g., from the plurality of phase channel responses), and may determine, based on the two or more clusters of phase channel responses, the two or more clusters of signals from the multiple signals. In such cases, each second cluster of the two or more clusters of phase channel responses may correspond to a respective cluster of the two or more clusters of signals. In other words, grouping of the multiple phase channel responses may inherently result in the grouping of the multiple signals. In some cases, the one or more thresholds may be based on at least one of: a movement speed of the first network entity or a target Doppler shift.

In some cases, at 515, the UE 115-c may filter the multiple phase channel responses associated with the two or more clusters of phase channel responses to generate a set of filtered phase channel responses.

At 520, the UE 115-c may detect, based on the two or more clusters (e.g., and based on the set of filtered phase channel responses), one or more communication conditions. In such cases, the one or more communication conditions include at least one of: one or more SFN conditions or one or more DPS conditions. In some cases, the UE 115-c may generate a flag based on detection of the one or more communication conditions.

In some cases, at 525, the UE 115-c may generate multiple bitmaps associated with the two or more clusters, where each bitmap of the multiple bitmaps corresponds to a respective cluster of the two or more clusters. For example, the two or more clusters may include a first cluster, a second cluster, and a third cluster, where the first cluster is associated with a first bitmap (e.g., based on a first set of signals from the multiple signals), the second cluster is associated with a second bitmap (e.g., based on a second set of signals from the multiple signals), and the third cluster is associated with a third bitmap (e.g., based on a third set of signals from the multiple signals).

In some cases, at 530, the UE 115-c nay determine (e.g., estimate), based on the multiple bitmaps, a respective set of one or more channel parameters associated with each cluster of the two or more clusters, where each respective set of one or more parameters may be based on a respective bitmap of the multiple bitmaps. For example, the UE 115-c may determine a first set of one or more channel parameters associated with the first cluster based on the first bitmap, may determine a second set of one or more channel parameters associated with the second cluster based on the second bitmap, and may determine a third set of one or more channel parameters associated with the third cluster based on the third bitmap. In such cases, each set of one or more channel parameters may include a respective delay spread, a respective Doppler shift, a respective Doppler spread, a respective SNR, or any combination thereof.

In some cases, at 535, the UE 115-c may combine the respective sets of one or more channel parameters to generate a set of one or more combined channel parameters associated with the two or more clusters. For example, the UE 115-c may combine the first set of one or more channel parameters, the second set of one or more channel parameters, and the third set of one or more channel parameters to generate the set of combined channel parameters.

In some cases, at 540, the UE 115-c may adapt one or more operations of the UE 115-c. In some cases, the UE 115-c may adapt the one or more operations based on detection of the one or more communication conditions. Additionally, or alternatively, the UE 115-c may adapt the one or more operations based on the flag. For example, the UE 115-c may adjust CSF reporting based on the flag, based on detection of the one or more communication conditions, or both.

Additionally, or alternatively, the UE 115-c may adapt (e.g., adjust, perform) the one or more operations based on the set of one or more combined channel parameters. For example, the UE 115-c may perform frequency tracking based on the set of one or more combined channel parameters, may perform demodulation based on the set of one or more combined channel parameters, or both.

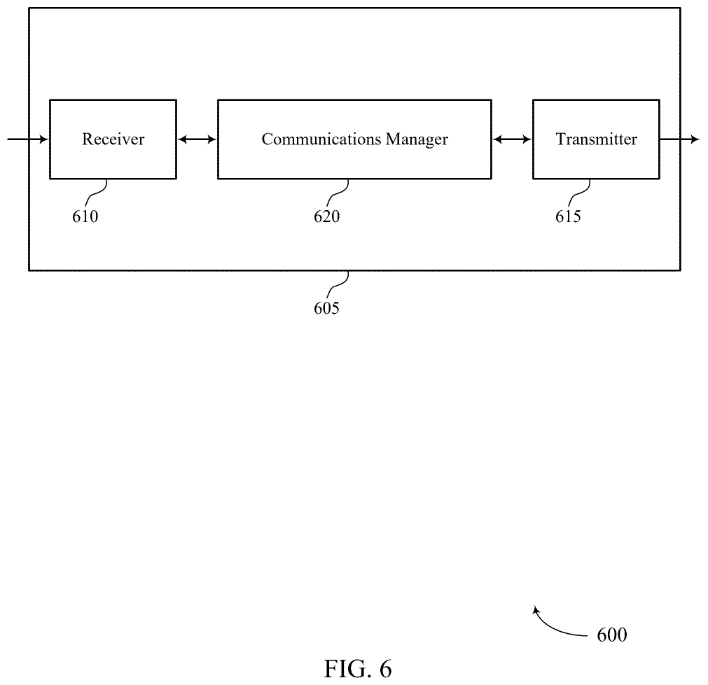

FIG. 6 shows a block diagram 600 of a device 605 that supports Doppler clustering techniques for per cluster parameter estimation and cluster detection in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to Doppler clustering techniques for per cluster parameter estimation and cluster detection). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to Doppler clustering techniques for per cluster parameter estimation and cluster detection). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of Doppler clustering techniques for per cluster parameter estimation and cluster detection as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a set of multiple signals via a set of multiple channels, where each signal of the set of multiple signals includes a same payload, and where a set of multiple Doppler shifts is associated with the set of multiple signals. The communications manager 620 is capable of, configured to, or operable to support a means for determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The communications manager 620 is capable of, configured to, or operable to support a means for detecting, based on the two or more clusters, one or more communication conditions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for Doppler clustering, which may result in reduced processing, reduced power consumption, and more efficient utilization of communication resources.

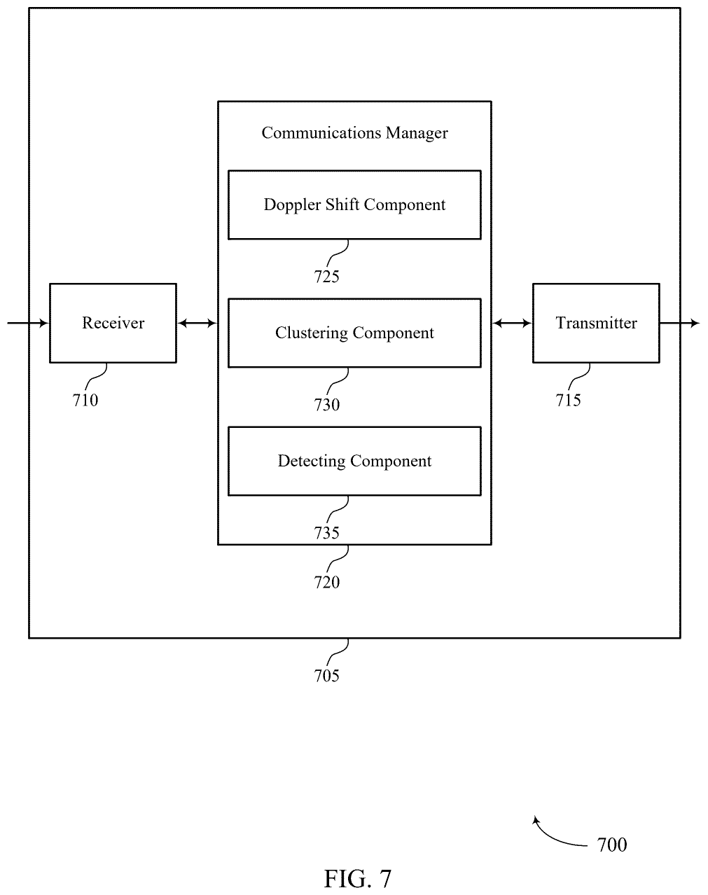

FIG. 7 shows a block diagram 700 of a device 705 that supports Doppler clustering techniques for per cluster parameter estimation and cluster detection in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to Doppler clustering techniques for per cluster parameter estimation and cluster detection). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to Doppler clustering techniques for per cluster parameter estimation and cluster detection). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of Doppler clustering techniques for per cluster parameter estimation and cluster detection as described herein. For example, the communications manager 720 may include a Doppler shift component 725, a clustering component 730, a detecting component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The Doppler shift component 725 is capable of, configured to, or operable to support a means for receiving a set of multiple signals via a set of multiple channels, where each signal of the set of multiple signals includes a same payload, and where a set of multiple Doppler shifts is associated with the set of multiple signals. The clustering component 730 is capable of, configured to, or operable to support a means for determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The detecting component 735 is capable of, configured to, or operable to support a means for detecting, based on the two or more clusters, one or more communication conditions.

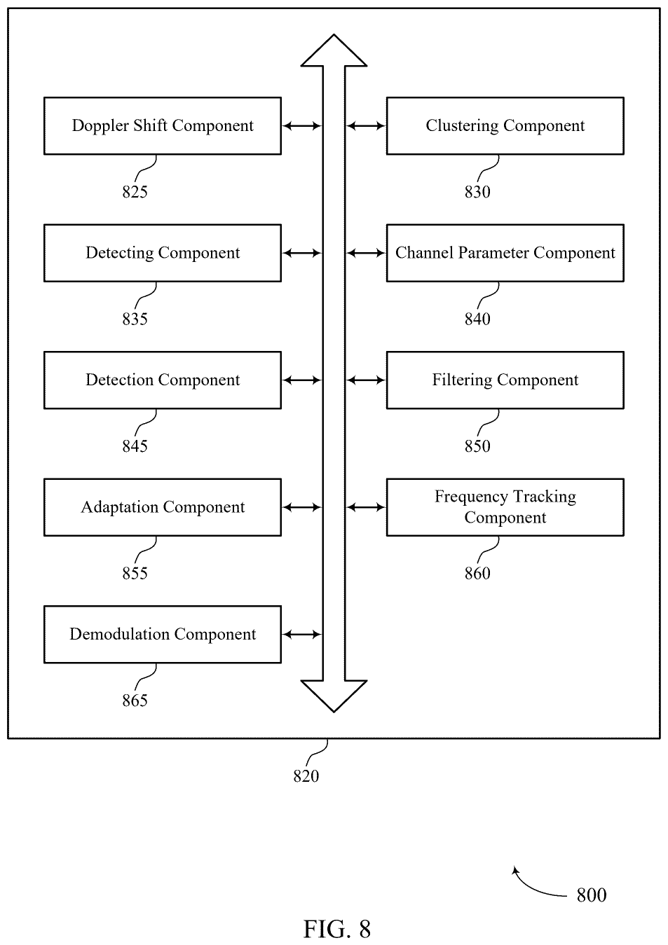

FIG. 8 shows a block diagram 800 of a communications manager 820 that supports Doppler clustering techniques for per cluster parameter estimation and cluster detection in accordance with one or more aspects of the present disclosure. The communications manager 820 may be an example of aspects of a communications manager 620, a communications manager 720, or both, as described herein. The communications manager 820, or various components thereof, may be an example of means for performing various aspects of Doppler clustering techniques for per cluster parameter estimation and cluster detection as described herein. For example, the communications manager 820 may include a Doppler shift component 825, a clustering component 830, a detecting component 835, a channel parameter component 840, a detection component 845, a filtering component 850, an adaptation component 855, a frequency tracking component 860, a demodulation component 865, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The Doppler shift component 825 is capable of, configured to, or operable to support a means for receiving a set of multiple signals via a set of multiple channels, where each signal of the set of multiple signals includes a same payload, and where a set of multiple Doppler shifts is associated with the set of multiple signals. The clustering component 830 is capable of, configured to, or operable to support a means for determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The detecting component 835 is capable of, configured to, or operable to support a means for detecting, based on the two or more clusters, one or more communication conditions.

In some examples, the channel parameter component 840 is capable of, configured to, or operable to support a means for generating a set of multiple bitmaps associated with the two or more clusters, where each bitmap of the set of multiple bitmaps corresponds to a respective cluster of the two or more clusters. In some examples, the channel parameter component 840 is capable of, configured to, or operable to support a means for determine, based on the set of multiple bitmaps, a respective set of one or more channel parameters associated each cluster of with the two or more clusters, where each respective set of one or more parameters is based on a respective bitmap of the set of multiple bitmaps.

In some examples, to support determining the respective set of one or more channel parameters associated with each cluster of the two or more clusters, the channel parameter component 840 is capable of, configured to, or operable to support a means for estimating, based on the set of multiple bitmaps, the respective set of one or more channel parameters associated with each cluster of the two or more clusters.

In some examples, each respective set of one or more channel parameters includes a respective delay spread, a respective Doppler shift, a respective Doppler spread, a respective SNR, or any combination thereof.

In some examples, the channel parameter component 840 is capable of, configured to, or operable to support a means combining the respective sets of one or more channel parameters to generate a set of one or more combined channel parameters associated with the two or more clusters.

In some examples, the frequency tracking component 860 is capable of, configured to, or operable to support a means for performing frequency tracking based on the set of one or more combined channel parameters.

In some examples, the demodulation component 865 is capable of, configured to, or operable to support a means for performing demodulation based on the set of one or more combined channel parameters.

In some examples, to support determining the two or more clusters of signals, the clustering component 830 is capable of, configured to, or operable to support a means for comparing each phase channel response of the set of multiple phase channel responses to one or more thresholds. In some examples, to support determining the two or more clusters of signals, the clustering component 830 is capable of, configured to, or operable to support a means for determining, based on the comparison, two or more clusters of phase channel responses from the set of multiple phase channel responses. In some examples, to support determining the two or more clusters of signals, the clustering component 830 is capable of, configured to, or operable to support a means for determining, based on the two or more clusters of phase channel responses, the two or more clusters of signals from the set of multiple signals, where each second cluster of the two or more clusters of phase channel responses corresponds to a respective cluster of the two or more clusters of signals.

In some examples, the one or more thresholds are based on at least one of: a movement speed of the first network entity or a target Doppler shift.

In some examples, the detection component 845 is capable of, configured to, or operable to support a means for generating a flag based on the detection of the one or more communication conditions.

In some examples, the adaptation component 855 is capable of, configured to, or operable to support a means for adapting, based on the flag, one or more operations.

In some examples, to support adapting the one or more operations, the adaptation component 855 is capable of, configured to, or operable to support a means for adjusting CSF reporting.

In some examples, the adaptation component 855 is capable of, configured to, or operable to support a means for adapting, based on the detection of the one or more communication conditions, one or more operations.

In some examples, to support adapting the one or more operations, the adaptation component 855 is capable of, configured to, or operable to support a means for adjusting CSF reporting.

In some examples, the filtering component 850 is capable of, configured to, or operable to support a means for filtering the set of multiple phase channel responses to generate a set of filtered phase channel responses, where, to detect the one or more communication conditions, the processing system is configured to detect, based on the two or more clusters comprising the set of filtered phase channel responses, the one or more communication conditions.

In some examples, the set of multiple signals includes a set of multiple repetitions of a same signal.

In some examples, to support receiving the set of multiple signals, the Doppler shift component 825 is capable of, configured to, or operable to support a means for receiving the set of multiple signals from one or more second network entities, where the one or more communication conditions are for communication between the first network entity and the one or more second network entities.

In some examples, the one or more second network entities include a single second network entity. In some examples, each signal of the set of multiple signals is associated with a respective communication path between the first network entity and the single second network entity.

In some examples, the one or more second network entities include a set of multiple second network entities. In some examples, each signal of the set of multiple signals is associated with a respective second network entity of the set of multiple second network entities.

In some examples, the first network entity includes a UE. In some examples, the one or more second network entities include one or more remote radio heads.

In some examples, the one or more communication conditions includes at least one of: one or more SFN conditions or one or more DPS conditions.

In some examples, the set of multiple Doppler shifts is indicative of the first network entity being configured to operate in a high speed train scenario.

In some examples, the set of multiple signals include either a set of multiple SSBs or a set of multiple TRSs.

In some examples, the set of multiple SSBs and the set of multiple TRSs are not associated with a QCL relationship.

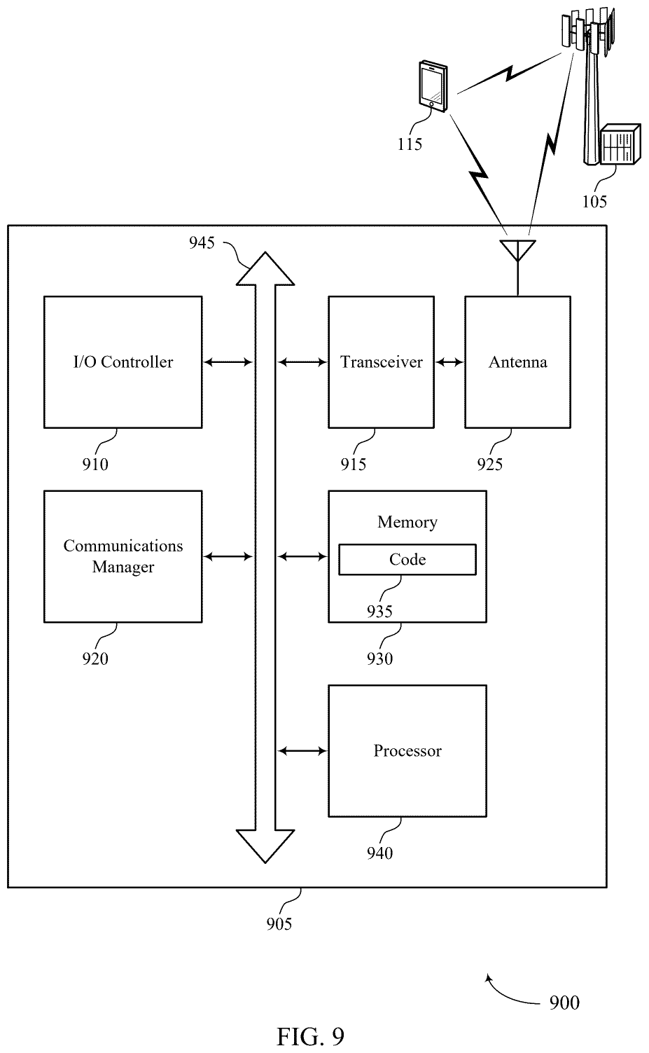

FIG. 9 shows a diagram of a system 900 including a device 905 that supports Doppler clustering techniques for per cluster parameter estimation and cluster detection in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting Doppler clustering techniques for per cluster parameter estimation and cluster detection). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a set of multiple signals via a set of multiple channels, where each signal of the set of multiple signals includes a same payload, and where a set of multiple Doppler shifts is associated with the set of multiple signals. The communications manager 920 is capable of, configured to, or operable to support a means for determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The communications manager 920 is capable of, configured to, or operable to support a means for detecting, based on the two or more clusters, one or more communication conditions.

By including or configuring the communications manager 920 in accordance with examples as described herein, the device 905 may support techniques for Doppler clustering, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of Doppler clustering techniques for per cluster parameter estimation and cluster detection as described herein, or the at least one processor 940 and the at least one memory 930 may be otherwise configured to, individually or collectively, perform or support such operations.

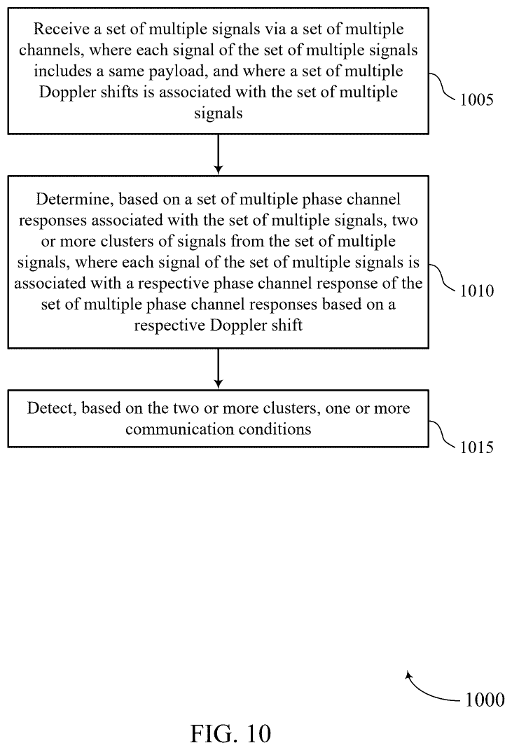

FIG. 10 shows a flowchart illustrating a method 1000 that supports Doppler clustering techniques for per cluster parameter estimation and cluster detection in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving a set of multiple signals via a set of multiple channels, where each signal of the set of multiple signals includes a same payload, and where a set of multiple Doppler shifts is associated with the set of multiple signals. The operations of 1005 may be performed in accordance with examples as disclosed herein. In some examples, aspects of the operations of 1005 may be performed by a Doppler shift component 825 as described with reference to FIG. 8.

At 1010, the method may include determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The operations of 1010 may be performed in accordance with examples as disclosed herein. In some examples, aspects of the operations of 1010 may be performed by a clustering component 830 as described with reference to FIG. 8.

At 1015, the method may include detecting, based on the two or more clusters, one or more communication conditions. The operations of 1015 may be performed in accordance with examples as disclosed herein. In some examples, aspects of the operations of 1015 may be performed by a detecting component 835 as described with reference to FIG. 8.

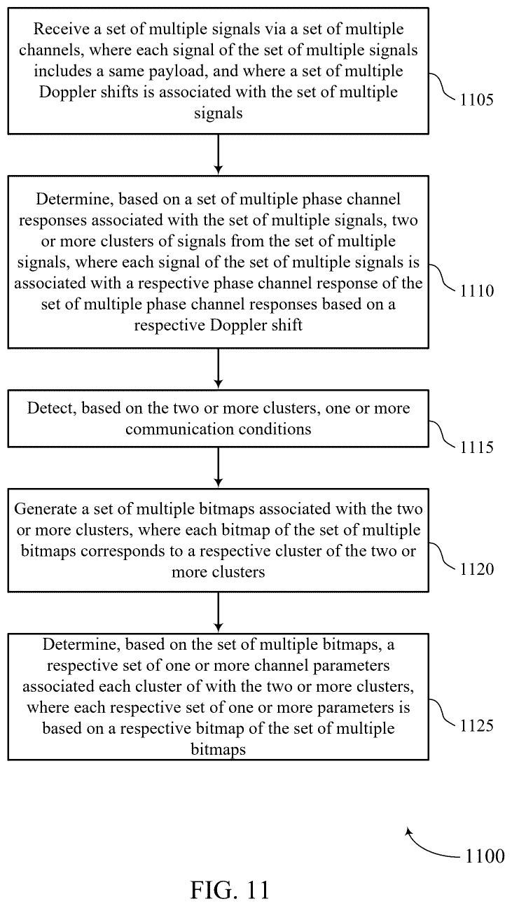

FIG. 11 shows a flowchart illustrating a method 1100 that supports Doppler clustering techniques for per cluster parameter estimation and cluster detection in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving a set of multiple signals via a set of multiple channels, where each signal of the set of multiple signals includes a same payload, and where a set of multiple Doppler shifts is associated with the set of multiple signals. The operations of 1105 may be performed in accordance with examples as disclosed herein. In some examples, aspects of the operations of 1105 may be performed by a Doppler shift component 825 as described with reference to FIG. 8.

At 1110, the method may include determining, based on a set of multiple phase channel responses associated with the set of multiple signals, two or more clusters of signals from the set of multiple signals, where each signal of the set of multiple signals is associated with a respective phase channel response of the set of multiple phase channel responses based on a respective Doppler shift. The operations of 1110 may be performed in accordance with examples as disclosed herein. In some examples, aspects of the operations of 1110 may be performed by a clustering component 830 as described with reference to FIG. 8.

At 1115, the method may include detecting, based on the two or more clusters, one or more communication conditions. The operations of 1115 may be performed in accordance with examples as disclosed herein. In some examples, aspects of the operations of 1115 may be performed by a detecting component 835 as described with reference to FIG. 8.

At 1120, the method may include generating a set of multiple bitmaps associated with the two or more clusters, where each bitmap of the set of multiple bitmaps corresponds to a respective cluster of the two or more clusters. The operations of 1120 may be performed in accordance with examples as disclosed herein. In some examples, aspects of the operations of 1120 may be performed by a channel parameter component 840 as described with reference to FIG. 8.

At 1125, the method may include determine, based on the set of multiple bitmaps, a respective set of one or more channel parameters associated each cluster of with the two or more clusters, where each respective set of one or more parameters is based on a respective bitmap of the set of multiple bitmaps. The operations of 1125 may be performed in accordance with examples as disclosed herein. In some examples, aspects of the operations of 1125 may be performed by a channel parameter component 840 as described with reference to FIG. 8.

The following provides an overview of aspects of the present disclosure:

Aspect 1: A method of wireless communication performed by a first network entity, comprising: receiving a plurality of signals via a plurality of channels, wherein each signal of the plurality of signals comprises a same payload, and wherein a plurality of Doppler shifts is associated with the plurality of signals; determining, based on a plurality of phase channel responses associated with the plurality of signals, two or more clusters of signals from the plurality of signals, wherein each signal of the plurality of signals is associated with a respective phase channel response of the plurality of phase channel responses based on a respective Doppler shift; and detecting, based on the two or more clusters, one or more communication conditions.

Aspect 2: The method of aspect 1, further comprising: generating a plurality of bitmaps associated with the two or more clusters, wherein each bitmap of the plurality of bitmaps corresponds to a respective cluster of the two or more clusters; and determine, based on the plurality of bitmaps, a respective set of one or more channel parameters associated each cluster of with the two or more clusters, wherein each respective set of one or more parameters is based on a respective bitmap of the plurality of bitmaps.

Aspect 3: The method of aspect 2, wherein determining the respective set of one or more channel parameters associated with each cluster of the two or more clusters comprises: estimating, based on the plurality of bitmaps, the respective set of one or more channel parameters associated with each cluster of the two or more clusters.

Aspect 4: The method of any of aspects 2 through 3, wherein each respective set of one or more channel parameters comprises a respective delay spread, a respective Doppler shift, a respective Doppler spread, a respective SNR, or any combination thereof.

Aspect 5: The method of any of aspects 2 through 4, further comprising: combining the respective sets of one or more channel parameters to generate a set of one or more combined channel parameters associated with the two or more clusters.

Aspect 6: The method of aspect 5, further comprising: performing frequency tracking based on the set of one or more combined channel parameters.

Aspect 7: The method of any of aspects 5 through 6, further comprising: performing demodulation based on the set of one or more combined channel parameters.

Aspect 8: The method of any of aspects 1 through 7, wherein determining the two or more clusters of signals comprises: comparing each phase channel response of the plurality of phase channel responses to one or more thresholds; determining, based on the comparison, two or more clusters of phase channel responses from the plurality of phase channel responses; and determining, based on the two or more clusters of phase channel responses, the two or more clusters of signals from the plurality of signals, wherein each second cluster of the two or more clusters of phase channel responses corresponds to a respective cluster of the two or more clusters of signals.

Aspect 9: The method of aspect 8, wherein the one or more thresholds are based on at least one of a movement speed of the first network entity or a target Doppler shift.

Aspect 10: The method of any of aspects 1 through 9, further comprising: generating a flag based on the detection of the one or more communication conditions.

Aspect 11: The method of aspect 10, further comprising: adapting, based on the flag, one or more operations.

Aspect 12: The method of aspect 11, wherein adapting the one or more operations comprises: adjusting channel state feedback reporting.

Aspect 13: The method of any of aspects 1 through 12, further comprising: adapting, based on the detection of the one or more communication conditions, one or more operations.

Aspect 14: The method of aspect 13, wherein adapting the one or more operations comprises: adjusting CSF reporting.

Aspect 15: The method of any of aspects 1 through 14, further comprising: filtering the plurality of phase channel responses to generate a set of filtered phase channel responses, wherein, to detect the one or more communication conditions, the first network entity detects, based on the two or more clusters comprising the set of filtered phase channel responses, the one or more communication conditions.

Aspect 16: The method of any of aspects 1 through 15, wherein the plurality of signals comprises a plurality of repetitions of a same signal.

Aspect 17: The method of any of aspects 1 through 16, wherein receiving the plurality of signals comprises: receiving the plurality of signals from one or more second network entities, wherein the one or more communication conditions are for communication between the first network entity and the one or more second network entities.

Aspect 18: The method of aspect 17, wherein the one or more second network entities comprise a single second network entity, and each signal of the plurality of signals is associated with a respective communication path between the first network entity and the single second network entity.

Aspect 19: The method of any of aspects 17 through 18, wherein the one or more second network entities comprise a plurality of second network entities, and each signal of the plurality of signals is associated with a respective second network entity of the plurality of second network entities.

Aspect 20: The method of any of aspects 17 through 19, wherein the first network entity comprises a UE, and the one or more second network entities comprise one or more remote radio heads.

Aspect 21: The method of any of aspects 1 through 20, wherein the one or more communication conditions comprise at least one of one or more SFN conditions or one or more DPS conditions.

Aspect 22: The method of any of aspects 1 through 21, wherein the plurality of Doppler shifts is indicative of the first network entity being configured to operate in a high speed train scenario.

Aspect 23: The method of any of aspects 1 through 22, wherein the plurality of signals comprise either a plurality of synchronization signal blocks or a plurality of tracking reference signals.

Aspect 24: The method of aspect 23, wherein the plurality of synchronization signal blocks and the plurality of tracking reference signals are not associated with a quasi-co-location relationship.

Aspect 25: A first network entity comprising one or more memories storing processor-executable code, and one or more processors coupled with the one or more memories and individually or collectively operable to execute the code to cause the first network entity to perform a method of any of aspects 1 through 24.

Aspect 26: A first network entity comprising at least one means for performing a method of any of aspects 1 through 24.

Aspect 27: A non-transitory computer-readable medium storing code the code comprising instructions executable by one or more processors to perform a method of any of aspects 1 through 24.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
receive a plurality of signals via a plurality of channels, wherein each signal of the plurality of signals comprises a same payload, and wherein a plurality of Doppler shifts is associated with the plurality of signals;
determine, based on a plurality of phase channel responses associated with the plurality of signals, two or more clusters of signals from the plurality of signals, wherein each signal of the plurality of signals is associated with a respective phase channel response of the plurality of phase channel responses based on a respective Doppler shift; and
detect, based on the two or more clusters, one or more communication conditions.

2. The first network entity of claim 1, wherein the processing system configured to:
generate a plurality of bitmaps associated with the two or more clusters, wherein each bitmap of the plurality of bitmaps corresponds to a respective cluster of the two or more clusters; and
determine, based on the plurality of bitmaps, a respective set of one or more channel parameters associated each cluster of with the two or more clusters, wherein each respective set of one or more parameters is based on a respective bitmap of the plurality of bitmaps.

3. The first network entity of claim 2, wherein, to determine the respective set of one or more channel parameters associated with each cluster of the two or more clusters, the processing system configured to:
estimate, based on the plurality of bitmaps, the respective set of one or more channel parameters associated with each cluster of the two or more clusters.

4. The first network entity of claim 2, wherein each respective set of one or more channel parameters comprises a respective delay spread, a respective Doppler shift, a respective Doppler spread, a respective signal to noise ratio, or any combination thereof.

5. The first network entity of claim 2, wherein the processing system is configured to:
combine the respective sets of one or more channel parameters to generate a set of one or more combined channel parameters associated with the two or more clusters.

6. The first network entity of claim 5, wherein the processing system configured to:
perform frequency tracking based on the set of one or more combined channel parameters.

7. The first network entity of claim 5, the processing system configured to:
perform demodulation based on the set of one or more combined channel parameters.

8. The first network entity of claim 1, wherein, to determine the two or more clusters of signals, the processing system configured to:
compare each phase channel response of the plurality of phase channel responses to one or more thresholds;
determine, based on the comparison, two or more clusters of phase channel responses from the plurality of phase channel responses; and
determine, based on the two or more clusters of phase channel responses, the two or more clusters of signals from the plurality of signals, wherein each second cluster of the two or more clusters of phase channel responses corresponds to a respective cluster of the two or more clusters of signals.

9. The first network entity of claim 8, wherein the one or more thresholds are based on at least one of: a movement speed of the first network entity or a target Doppler shift.

10. The first network entity of claim 1, wherein the processing system configured to:
generate a flag based on the detection of the one or more communication conditions.

11. The first network entity of claim 10, wherein the processing system configured to:
adapt, based on the flag, one or more.

12. The first network entity of claim 11, wherein, to adapt the one or more operations, the processing system configured to:
adjust channel state feedback reporting.

13. The first network entity of claim 1, wherein the processing system configured to:
adapt, based on the detection of the one or more communication conditions, one or more operations.

14. The first network entity of claim 13, wherein, to adapt the one or more operations, the processing system is configured to:
adjust channel state feedback reporting.

15. The first network entity of claim 1, wherein the processing system configured to:
filter the plurality of phase channel responses to generate a set of filtered phase channel responses, wherein, to detect the one or more communication conditions, the processing system is configured to detect, based on the two or more clusters comprising the set of filtered phase channel responses, the one or more communication conditions.

16. The first network entity of claim 1, wherein the plurality of signals comprises a plurality of repetitions of a same signal.

17. The first network entity of claim 1, wherein, to receive the plurality of signals, the processing system configured to:
receive the plurality of signals from one or more second network entities, wherein the one or more communication conditions are for communication between the first network entity and the one or more second network entities.

18. The first network entity of claim 17, wherein the one or more second network entities comprise a single second network entity, and wherein each signal of the plurality of signals is associated with a respective communication path between the first network entity and the single second network entity.

19. The first network entity of claim 17, wherein the one or more second network entities comprise a plurality of second network entities, and wherein each signal of the plurality of signals is associated with a respective second network entity of the plurality of second network entities.

20. The first network entity of claim 17, wherein the first network entity comprises a user equipment (UE), and wherein the one or more second network entities comprise one or more remote radio heads.

21. The first network entity of claim 1, wherein the one or more communication conditions comprise at least one of:
one or more single frequency network (SFN) conditions, or
one or more dynamic point selection (DPS) conditions.

22. The first network entity of claim 1, wherein the plurality of Doppler shifts is indicative of the first network entity being configured to operate in a high speed train scenario.

23. The first network entity of claim 1, wherein the plurality of signals comprise either a plurality of synchronization signal blocks or a plurality of tracking reference signals.

24. The first network entity of claim 23, wherein the plurality of synchronization signal blocks and the plurality of tracking reference signals are not associated with a quasi-co-location relationship.

25. A method of wireless communication performed by a first network entity, comprising:
receiving a plurality of signals via a plurality of channels, wherein each signal of the plurality of signals comprises a same payload, and wherein a plurality of Doppler shifts is associated with the plurality of signals;
determining, based on a plurality of phase channel responses associated with the plurality of signals, two or more clusters of signals from the plurality of signals, wherein each signal of the plurality of signals is associated with a respective phase channel response of the plurality of phase channel responses based on a respective Doppler shift; and
detecting, based on the two or more clusters, one or more communication conditions.

26. The method of claim 25, further comprising:
generating a plurality of bitmaps associated with the two or more clusters, wherein each bitmap of the plurality of bitmaps corresponds to a respective cluster of the two or more clusters; and
determine, based on the plurality of bitmaps, a respective set of one or more channel parameters associated each cluster of with the two or more clusters, wherein each respective set of one or more parameters is based on a respective bitmap of the plurality of bitmaps.

27. The method of claim 26, wherein determining the respective set of one or more channel parameters associated with each cluster of the two or more clusters comprises:
estimating, based on the plurality of bitmaps, the respective set of one or more channel parameters associated with each cluster of the two or more clusters.

28. The method of claim 25, wherein determining the two or more clusters of signals comprises:
comparing each phase channel response of the plurality of phase channel responses to one or more thresholds;
determining, based on the comparison, two or more second clusters of phase channel responses from the plurality of phase channel responses; and
determining, based on the two or more second clusters of phase channel responses, the two or more clusters of signals from the plurality of signals, wherein each second cluster of the two or more second clusters of phase channel responses corresponds to a cluster of the two or more clusters of signals.

29. An apparatus for wireless communication, comprising:
means for receiving a plurality of signals via a plurality of channels, wherein each signal of the plurality of signals comprises a same payload, and wherein a plurality of Doppler shifts is associated with the plurality of signals;
means for determining, based on a plurality of phase channel responses associated with the plurality of signals, two or more clusters of signals from the plurality of signals, wherein each signal of the plurality of signals is associated with a respective phase channel response of the plurality of phase channel responses based on a respective Doppler shift; and
means for detecting, based on the two or more clusters, one or more communication conditions.

30. A non-transitory computer-readable medium having code for wireless communication stored thereon that, when executed by a network node, causes the network node to:
receive a plurality of signals via a plurality of channels, wherein each signal of the plurality of signals comprises a same payload, and wherein a plurality of Doppler shifts is associated with the plurality of signals;
determine, based on a plurality of phase channel responses associated with the plurality of signals, two or more clusters of signals from the plurality of signals, wherein each signal of the plurality of signals is associated with a respective phase channel response of the plurality of phase channel responses based on a respective Doppler shift; and
detect, based on the two or more clusters, one or more communication conditions.
